(19) United States
(12) Patent Application Publication
(10) Pub. No.: US 2017/0293717 A1
(43) Pub. Date: Oct. 12, 2017

(54) SYSTEM AND METHOD FOR REMOTE PATHOLOGY CONSULTATION DATA TRANSFER AND STORAGE

(71) Applicant: Bingsheng Technology (Wuhan) Co., Ltd., Wuhan (CN)

(72) Inventor: Jiangsheng YU, Abington, PA (US)

(73) Assignee: Bingsheng Technology (Wuhan) Co., Ltd., Wuhan (CN)

(21) Appl. No.: 15/482,740

(22) Filed: Apr. 8, 2017

Related U.S. Application Data
(60) Provisional application No. 62/319,961, filed on Apr. 8, 2016.

(30) Foreign Application Priority Data
Apr. 15, 2016 (CN) 201610230006.7

(51) Int. Cl. G06F 19/00; G06F 17/30

(52) U.S. Cl. CPC G06F 19/321; G06F 17/30569; G06F 19/345; H04L 67/1097

(57) ABSTRACT

A synchronized data processing system and method are provided for remote pathology consultation to address performance issues caused by resources conflicts between upload from referral sources and online image browsing by consultants when the two are geographically distant (e.g., in China and the United States). The system includes two parts—a local end that is in close geographic proximity to referral sources and a remote end that is in close geographic proximity to referral sources consultants. Image data uploaded to the local end by referral sources is automatically synchronized to the remote end for consultant access. In the system, an asynchronous message queue is included to prevent out-of-resource operation failures in slide file format conversion. A three-layered storage architecture, including a temporary storage, two synchronized cloud storages, and a permanent storage, is used for slide image data storage.

### CROSS-REFERENCE TO RELATED APPLICATION

This application claims the benefit of the U.S. Patent Application No. 62/319,961, filed Apr. 8, 2016, and Chinese Patent Application No. 201610230006.7, filed Apr. 15, 2016. The entire disclosures of these applications are incorporated by reference.

### FIELD

The present disclosure generally relates to medical diagnosis and more specifically to a data transfer and storage system and method for remote pathology consultation.

### BACKGROUND

Telepathology between China and the United States has developed rapidly in recent years. For example, UCLA started pathology consultation service with the Second Affiliated Hospital of Zhejiang University in 2013; and the Cleveland Clinic and Guangzhong Zhongshan Hospital established a joint remote pathology diagnostic center in southern China in 2014. The introduction of whole-slide imaging scanners facilitates remote pathology consultation processes by digitized high-resolution slide images observed in microscopy at referral ends (clients) and virtually reproducing the images at consultant ends. While the whole-slide imaging technique significantly improves the diagnostic quality, the storage and transfer challenges of big data for telepathology have arisen.

In conventional telepathology systems, referral sources upload pathology slide data to a central server for management and storage so consultants can remotely access the data online to diagnose. The system with the central server may reduce the burdens of data maintenance from clients (referral sources) and consultants. U.S. Pat. No. 8,565,498 describes a second-opinion network in which a scanning center (an example central server) provides data communication between referral sources and consultants via wide-area networks. However, when the referral sources and consultants are located in two geographically distant countries (e.g., China and the United States), the location of the central server and data storage significantly affects the data transfer and online access response time. The referral source, for example, located in China, may prefer a local central server to conveniently and effectively upload slide data. However, the network latency makes browsing images online impractical for consultants who are located in a remote foreign country, for example, top hospitals on the east coast of the United States. On the other hand, if the central server is located close to the consultants in the United States, it may take the client hospitals in China (the referral source) a long time (5 to 10 hours) to upload the data for a single case, and the data transfer may be intermittently interrupted due to unreliable networks. In addition, the clients may experience very slow response times when requesting slide image access from such server in the United States.

In a telepathology system, referral sources may be equipped with digital scanners from different vendors, and the file formats of whole-slide images from different vendors may not be compatible with each other. There is a need for the central server to convert different formats to a vendor-neutral format to reduce system complexity. In addition, cloud storage usually only allows static file access, thus converting a slide file to a static image package (e.g., Deep Zoom format, etc.) may allow the slide file be accessed through the cloud storage. Static images are created from the original slide file, and are stored in the cloud storage. Unlike dynamic images that are dynamically created from the original slide file in response to an access request, the static images are created beforehand and are available for access before receiving the access request.

Further, due to the large size of the whole-slide image (e.g., 300 MB to 2 GB), the format conversion is highly demanding on computer resources (e.g., CPU and memory, etc.). The conversion process forms a bottleneck to system overall performance, and it may also potentially result in a failed conversion operation when several slide files are uploaded and processed simultaneously. Thus, a mechanism needs to be carefully designed to prevent failures in the format conversion.

A typical consultation case may have, for example, 5 to 15 slides with a total data size of 1.5 GB to 30 GB. Slide data accumulate in the system as the remote pathology consultation progresses and more cases are uploaded. To reduce system operation costs, slide files are moved to an economical permanent storage location after a consultant reviews the case. In addition, to provide temporary access for clients during file conversion, the original slide file resides in the system until it is deleted upon completion of the conversion. A layered data storage architecture is helpful for storing slide files in different formats (e.g., vendor-specific formats, vendor-neutral format, etc.) in different life cycles of the operations.

The background description provided here is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

The present disclosure presents a synchronized data transfer system and method for remote pathology consultation. In one embodiment of the present disclosure, the system includes two parts, for example, a local end, which is in close geographic proximity to clients, and a remote end, which is in close geographic proximity to consultants,. The servers at the local end accept slide data uploading from clients, perform format conversion, and store data to a local cloud storage. Data in the local cloud storage is then automatically synchronized to a remote cloud storage. Web servers on the remote end access the remote cloud storage to provide data access to consultants.

An asynchronous message queue is designed in the presented disclosure as a mechanism to prevent failures in slide file format conversion. The arrival of a slide is signaled as a message in the queue, and a processing server polls the queue and processes only one slide at one time, thus preventing format conversion failure due to resource exhaustion. To improve the slide file conversion throughput, a processing server cluster with automatic scaling is configured to adjust the server numbers dynamically based on the number of messages residing in the message queue.

In one embodiment of the present disclosure, a three-layered storage architecture is presented for storing slide data in a remote pathology consultation. The architecture may include one temporary storage, two synchronized cloud storages, and a permanent storage.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

These and other features and advantages of the present disclosure will become more readily appreciated through an understanding of the following detailed description in connection with the accompanying drawings:

FIG. 1 is a schematic block diagram illustrating one embodiment of an example system for synchronized data transfer and storage for a remote pathology consultation.

FIG. 2 is a schematic flow diagram illustrating the data transfer process related to the system depicted in FIG. 1.

FIG. 3A is a schematic block diagram illustrating an example three-layered storage system for storing slide data for a remote pathology consultation.

FIG. 3B is a flow diagram illustrating the method for accessing slide data related to the storage system depicted in FIG. 3A.

In the drawings, reference numbers may be reused to identify similar and/or identical elements.

### DETAILED DESCRIPTION OF THE PREFERRED EMBODIMENT

Telepathology systems have been developed for remote pathology consultation, which may allow clients to upload data slides, store and transfer the data to remote consultants for review. Traditionally, uploading big volume of digitized high-resolution slide images and remotely accessing/reviewing such images simultaneously may cause resource conflict and large image data conversion may cause resource bottleneck, therefore negatively impact system performance The present disclosure presents systems with at least two synchronized central servers located in close geographic proximity to the clients and consultants respectively to prevent such issues. In addition, an asynchronous message queue mechanism is also included in the central server to prevent failures during slide file format conversion.

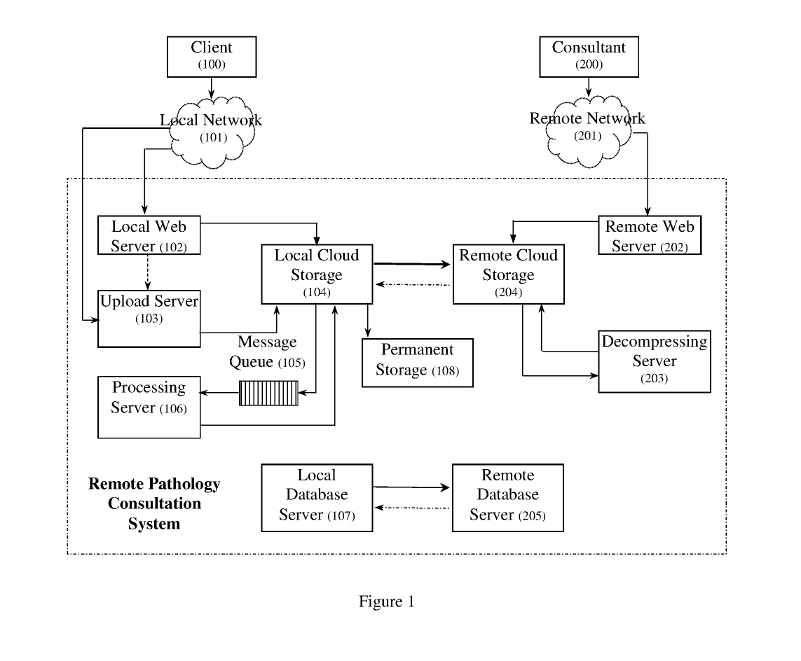

FIG. 1 is a block diagram of an example implementation of a data transfer and storage system for remote pathology consultation according to an embodiment of the present disclosure. The system may include a local end (client) 100 and a remote end (consultant) 200.

The local end 100 of the system may include four types of servers: a local web server 102, an upload server 103, a processing server 106, and a local database server 107. The local web server 102 is set up for clients 100 to register new cases, upload initial diagnostic reports and clinical documents, browse slide images, and download consultation reports. The upload server 103 is dedicated to receiving whole-slide images uploaded from clients. The processing server 106 transforms the slide files from vendor-specific formats to a vendor-neutral format (e.g., a standard Deep Zoom format (described later)) and compresses the Deep Zoom file package to facilitate data synchronization from local cloud storage 104 to remote cloud storage 204. The three servers communicate with the local database server 107 to share case information and consultation status.

The remote end 200 of the system may include three types of servers: a remote web server 202, a decompressing server 203, and a remote database server 205. The remote web server 202 allows consultants to access the case information, download the initial report, view the slide images, make diagnoses online, and upload the consultation report. The decompressing server 203 fetches the compressed Deep Zoom file package from the remote cloud storage 204 and performs decompression operations. Similarly, the two servers communicate with the database server 205 to exchange case information and status.

The two database servers 107 and 205 at the local and remote ends are configured as dual master-slave databases to exchange case information and consultation progress.

Both web servers 102 and 202 at the local and remote ends can be configured as server clusters with load balancers and automatic scaling to adjust the numbers of web servers required to handle client request spikes and evenly distribute load requests among web servers.

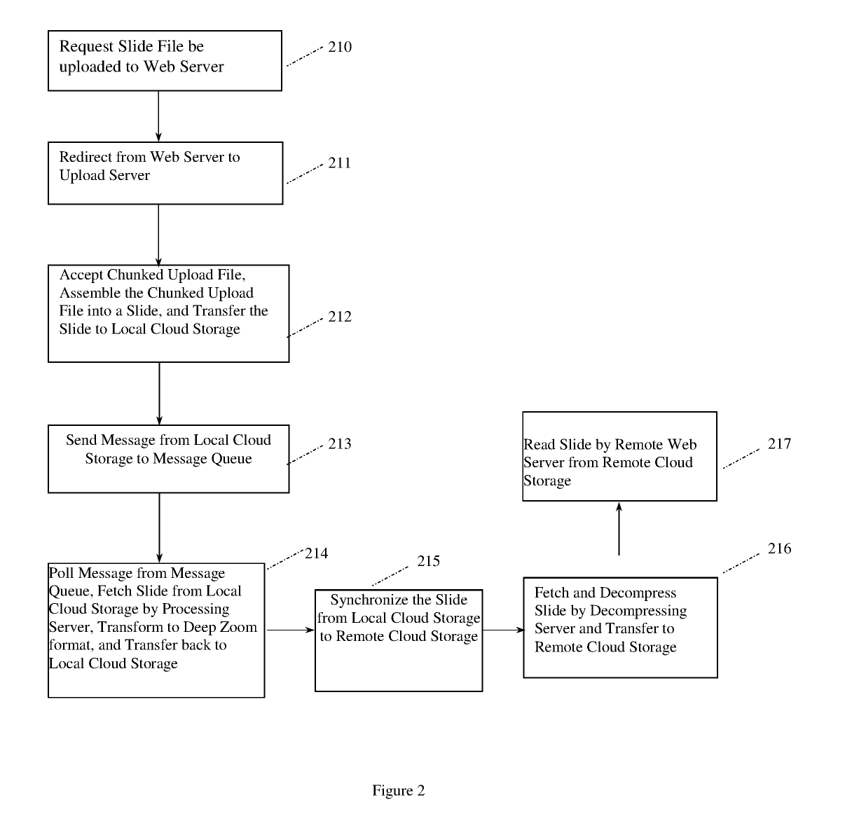

FIG. 2 is a flow diagram illustrating the data transfer process for the system described in FIG. 1.

In step 210, the client 100 accesses the local web server 102 through a local wide-area network 101 to register a new consultation case and upload the original diagnostic report and related clinical documents.

In step 211, when the client 100 requests a slide data upload, the local web server 102 returns the IP address of the upload server 103, which communicates directly with the client 100 to accept slide data upload.

In step 212, due to the large size of a whole-slide image (e.g., 300 MB to 2 GB), the web-browser-based client-side software first divides the slide file into small, fixed-size chunks that are sequentially uploaded to the upload server 103. The key advantage of a chunked upload is a resumable data transfer. In case of upload interruption caused by network or other problems, data transfers can be resumed without the need to start from the beginning. The upload server assembles all the chunks back into the original slide file after the last piece is uploaded, then transfers the slide file to the local cloud storage 104.

In step 213, after receiving the slide file from the upload server 103, the local cloud storage 104 posts a message to a slide message queue 105 (detailed descriptions for the mechanism to use the slide message queue 105 are included later of this disclosure). The message includes the slide file name and location, which is read by the processing server 106. In case the processing server 106 is configured as a server cluster, a message retrieved by one processing server becomes unavailable to other processing servers to avoid duplicate processing. The processing server 106 needs to delete the message from the message queue 105 after the slide file is processed. If the message is not deleted within 12 hours after it is retrieved by the processing server 106, the message queue 105 triggers an alarm to a system administration, indicating a message processing failure.

In step 214, the processing server 106 polls messages from the message queue 105. When a message appears, the processing server 106 retrieves it; otherwise the server waits for 10 seconds. The processing server 106 fetches the slide file from the local cloud storage 104 based on the file name and location included in the message. The slide file is converted from the original vendor format to the standard Deep Zoom format. Then, two copies of the converted Deep Zoom file package are transferred back to the local cloud storage 104. One copy is for client access through the local web server 102; the other is compressed into a single file before synchronized to the remote server 204. Since a Deep Zoom file package is made of tens of thousands of small image files, the pre-compression operation significantly reduces the synchronization time by avoiding the long handshaking time caused by transferring a large number of small image files.

In step 215, once the local cloud storage 104 receives the compressed Deep Zoom slide file, a data synchronization to the remote cloud storage 204 is automatically initiated. Similar to the slide file upload in step 212, the synchronization may use a chunked-data transfer mechanism for resumable transfer.

In step 216, after the slide file is synchronized, the remote cloud storage 204 sends a notification to the decompressing server 203, which fetches the slide file from the remote cloud storage 204. The notification can be, for example, a simple HTTP request or a message in the message queue 105 similar to the one used in step 213. The decompressing server 203 decompresses the slide file back to the Deep Zoom format file package and sends it back to the remote cloud storage 204 for further access by the consultants 200. The decompressing server 203 may be configured as a server cluster, in which the number of servers is adjusted to accommodate new slide files pending in the remote storage so that the decompressing operations can be performed in a timely manner.

In step 217, when the consultants 200 review cases and browse slides data online via a remote wide-area network 201, the remote web server 202 reads slide images from the remote cloud storage 204 and returns them to the consultants 200.

When the local cloud storage 104 receives a new slide from the upload server 103, it notifies the processing server 106 about the arrival of the new slide. Conventionally, the local cloud storage 104 may notify the processing server by sending a HTTP request to the processing server 106. The processing server 106 then responds to the request by creating a new thread, which fetches the slide from the local cloud storage 104 and performs format conversion. One potential problem for such communication is that the processing server 106 may be overloaded by responding to multiple HTTP requests. Due to the large size of whole-slide image files, the format conversion operation demands high CPU and memory resources. The format conversion operations may fail when the processing server 106 simultaneously processes several slides. This problem may not be eliminated by a processing server cluster with automatic scaling and load balancing. The mechanism in the present disclosure applies an asynchronous message queue in which the local cloud storage 104 posts new messages for new slides and the processing server 106 polls the messages at a fixed interval. When a new message appears in the message queue 105, the processing server 106 retrieves the message, fetches a slide file from the cloud storage 104, and performs format conversion. Upon the completion of the format conversion, the processing server 106 actively deletes the message from the message queue 105 and reads the next message, if one exists. The message queue mechanism guarantees the processing server 106 processes only one slide at a time and thus prevents the processing sever 106 from becoming overloaded. To improve the slide processing throughput, a processing server cluster with automatic scaling may be configured to adjust the server numbers dynamically based on the number of messages residing in the message queue 105. For example, a scaling configuration may be implemented to linearly increase the number of servers with the number of pending new slide files, while setting a limit to the maximum server number (e.g., 20 servers, etc.) As an alternative approach, a processing server with a graphics processing unit (GPU) can be used to accelerate the slide processing by taking advantage of the Deep Zoom format's ability to run conversions in parallel.

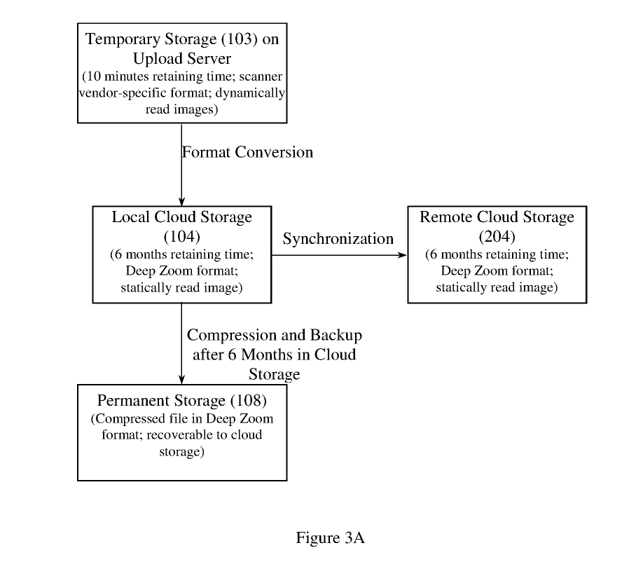

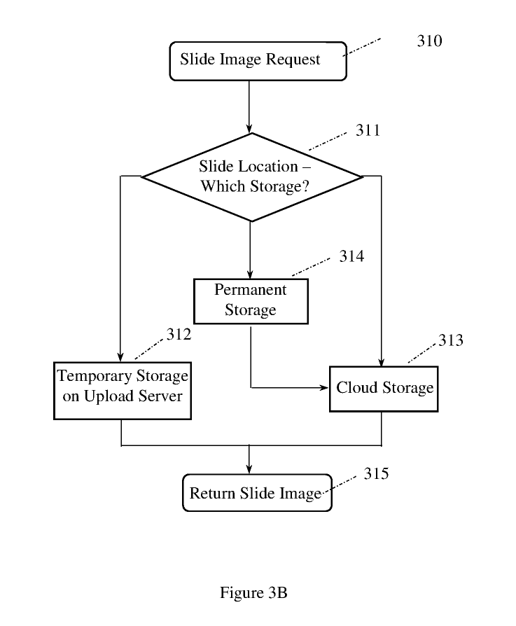

FIG. 3A is a block diagram illustrating a three-layered storage architecture in another embodiment of the system depicted in FIG. 1 of the present disclosure for storing slide data in remote pathology consultation. The system may include a temporary storage on an upload server 103, a local cloud storage 104, a remote cloud storage 105, and a permanent storage 108.

A client uploads a whole-slide image in chunks to the upload server 103, which assembles the chunks back to the original slide file and saves it on the temporary storage (e.g., a local hard drive). Prior to the completion of the format conversion, if the client sends an access requests, the upload server 103 dynamically reads images in the original slide file in the vendor-specific format. The original slide file remains for a duration of around 10 minutes until the processing server completes the format conversion and notifies the upload server 103 to delete the file in the vendor-specific format.

The local cloud storage 104 and the remote cloud storage 204, are the core parts of the layered storage system. New slide files at the local cloud storage 104 are automatically synchronized to the remote cloud storage 204. Slide files are stored as static image files in, for example, a Deep Zoom format to provide online browsing access to the consultants 200 and the clients 100. The local cloud storage 104 also acts as a shared file storage location between the upload server 103 and the processing server 106. The upload server 103, upon receiving a new slide, stores it to the local cloud storage 104, and posts a message to the message queue 105 to notify the processing server 106 to transfer the slide to the local hard drive and perform format conversion. Slide files are kept for six months in the cloud storages 104 and 204 after a consultant reviews the case, and then compressed and moved to the permanent storage 108. The files stored in the permanent storage 108 can be kept for years (e.g., two years, five years, 10 years, 15 years, 20 years, or even longer).

Slide files in the Deep Zoom format are compressed and stored in the permanent storage 108. Data in the permanent storage 108 is first transferred to the cloud storages 104 and 204 before it can be accessed. It may take a few hours to retrieve data from the permanent storage 108.

In the example three-layered storage architecture, the unit storage costs, from high to low order, are temporary storage, cloud storage, and permanent storage.

In the cloud storages 104, 204, and the permanent storage 108, slide files are stored as Deep Zoom file packages. Deep Zoom is an image transfer and viewing technique developed by Microsoft for browsing high-resolution images in a web browser. In Deep Zoom format, a high-resolution image is partitioned into tiles at different resolution levels to form a pyramid directory structure in which two neighboring layers differ in resolution by a factor of two and the bottom layer has the highest resolution. Deep Zoom provides a fast web response to users by transmitting and displaying only a partial set of images, (i.e., images of interest), in the viewing region at a given resolution.

FIG. 3B is a flow diagram illustrating an example method for the system to locate slide data in the three-layered storage architecture depicted in FIG. 3A.

In step 310, a client or a consultant sends slide image requests to a web server at the local end or the remote end.

In step 311, the web server queries a database server to find out whether the slide data is stored in a temporary storage, a cloud storage, or a permanent storage. The database server has a dedicated table in which each slide file has a record with fields showing the file size, the upload start time and finish time, and the chunked upload size, as well as an integer field marking the slide file location.

In step 312, the web server communicates to the upload server, which reads slide images dynamically from the original slide file in the vendor-specific format.

In step 313, the web server accesses the cloud storage to read the static images in the Deep Zoom file package that are converted from the uploaded slide images.

In step 314, the converted slide image data is compressed and moved to the permanent storage. The compressed slide image data may also be first transferred to the cloud storage and then recovered to the Deep Zoom file package.

In step 315, the web server returns the requested slide images to the client or the consultant.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A data processing system for remote pathology consultation to allow a pathologist to render pathology diagnostic opinions in connection with image data uploaded from a first site that is remote from a second site where the pathologist is located, the system comprising:
the first site having a first processor configured to upload a plurality of slides of image data from at least one referral resource, the plurality of slides of image data includes at least one format;
the second site having a second processor configured for the pathologist to access the plurality of slides of image data;
a first cloud storage located in close geographic proximity to the first site, the first cloud storage being configured to store the plurality of slides of image data uploaded from the at least one referral resource;
a second cloud storage located in close geographic proximity to the second site, the second cloud storage being configured to:
store the plurality of slides of image data that is transferred and synchronized from the first cloud storage; and
provide access to the transferred and synchronized plurality of slides of image data stored in the second cloud storage for the pathologist.

2. The data processing system of claim 1, wherein the at least one format is converted to a vendor-neutral format.

3. The data processing system of claim 1, wherein the plurality of slides of image data is converted to a static image package and is stored in the first cloud storage and the second cloud storage.

4. The data processing system of claim 3, the static image package includes a Deep Zoom format.

5. The data processing system of claim 3, the static image package is moved from the first cloud storage to a permanent storage after the pathologist completes reviewing the plurality of slides of image data.

6. The data processing system of claim 5, the static image package is compressed before being moved from the first cloud storage to the permanent storage.

7. The data processing system of claim 5, wherein the first site further comprises a temporary storage configured to store the uploaded plurality of slides of image data before the conversion is completed.

8. The data processing system of claim 7, the temporary storage is configured to keep the image data for a first retaining time, the first cloud storage and the second cloud storage are configured to keep the image data for a second retaining time, the permanent storage is configured to keep the image data for a third retaining time, wherein the first retaining time is less than the second retaining time and the second retaining time is less than the third retaining time.

9. The data processing system of claim 7, wherein the temporary storage is a hard drive.

10. The data processing system of claim 7, the first processor is configured to upload the plurality of slides of image data in chunks, assemble the chunks back to the plurality of slides image data, store the plurality of slides of image data on the temporary storage.

11. The data processing system of claim 1 further comprising an asynchronous message queue configured to receive a plurality of messages in response to receiving the plurality of slides of the image data respectively, wherein the plurality of messages are polled, the plurality of slides are processed in parallel by a server cluster, and the server cluster includes a plurality of servers each processing one of the plurality of slides at a time.

12. A data processing method for remote pathology consultation to allow a pathologist to render pathology diagnostic opinions in connection with image data uploaded from a first site that is remote from a second site where the pathologist is located, the method comprising:
uploading a plurality of slides of image data from at least one referral resource at the first site, the plurality of slides of image data includes at least one format;
accessing the plurality of slides of image data by the pathologist from the second site;
storing the plurality of slides of image data uploaded from the at least one referral resource in a first cloud storage located in close geographic proximity to the first site;
transferring and synchronizing the plurality of slides of image data from the first cloud storage to a second cloud storage located in close geographic proximity to the second site; and
providing access to the transferred and synchronized plurality of slides of image data stored in the second cloud storage for the pathologist.

13. The data processing method of claim 12 further comprising converting the at least one format to a vendor-neutral format.

14. The data processing method of claim 12 further comprising converting the plurality of slides of image data to a static image package and is storing the static image package in the first cloud storage and the second cloud storage.

15. The data processing method of claim 14 further comprising moving the static image package from the first cloud storage to a permanent storage after the pathologist completes reviewing the plurality of slides of image data.

16. The data processing method of claim 15 further comprising compressing the static image package and moving the compressed static image package from the first cloud storage to the permanent storage.

17. The data processing method of claim 15 further comprising storing wherein the uploaded plurality of slides of image data in a temporary storage before the conversion is completed.

18. The data processing method of claim 17 further comprising:
keeping the image data in the temporary storage for a first retaining time;
keeping the image data in the first cloud storage and the second cloud storage for a second retaining time; and
keeping the image data the permanent storage for a third retaining time,
wherein the first retaining time is less than the second retaining time and the second retaining time is less than the third retaining time.

19. The data processing method of claim 17 further comprising:
uploading the plurality of slides of image data in chunks;
assembling the chunks back to the plurality of slides image data; and
storing the plurality of slides of image data on the temporary storage.

20. The data processing method of claim 12 further comprising:
receiving a plurality of messages by an asynchronous message queue in response to receiving the plurality of slides of the image data respectively; and
polling the plurality of messages and processing the plurality of slides in parallel by a server cluster, wherein the server cluster includes a plurality of servers each processing one of the plurality of slides at a time.
